(19) United States
(12) Patent Application Publication
(10) Pub. No.: US 2011/0031426 A1
(43) Pub. Date: Feb. 10, 2011

(54) ENGINE CONTROL VALVE SYSTEM WITH MOTOR

(75) Inventor: Jeff Tyler, Newark, NY (US)

Correspondence Address: BROWN & MICHAELS, PC;400 M & T BANK BUILDING, 118 NORTH TIOGA ST, ITHACA, NY, 14850, US

(73) Assignee: G. W. LISK COMPANY, INC., Clifton Springs, NY (US)

(21) Appl. No.: 12/936,448

(22) PCT Filed: Apr. 7, 2009
(86) PCT No.: PCT/US09/39755

§ 371 Date: Oct. 5, 2010

Related U.S. Application Data
(60) Provisional application No. 61/042,807, filed on Apr. 7, 2008.

(51) Int. Cl. F16K 31/44

(52) U.S. Cl. 251/251

(57) ABSTRACT

A system for operating a valve comprising a motor shaft driven by a motor; a first cam with a profile mounted to the motor shaft, a second cam with a profile mounted to the motor shaft; a non-contact sensor proximate to the first cam; and a valve actuator. The valve actuator follows the profile of the second cam. A selected position of the valve actuator may be set by activating the motor to a position determined by sensing the first cam profile by the non-contact sensor.

### REFERENCE TO RELATED APPLICATIONS

This application claims one or more inventions which were disclosed in Provisional Application Number 61/042,807 filed Apr. 7, 2008, entitled “ENGINE CONTROL VALVE SYSTEM WITH MOTOR”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of engine control valve systems. More particularly, the invention pertains to an exhaust gas recirculation system, turbo charger waste gate, and cooler bypass systems with a valve operated by a motor.

2. Description of Related Art

Prior art electric exhaust gas recirculation (EGR), turbo charger waste gate, and cooler bypass valve systems suffer from multiple problems. Common problems associated with the electric EGR, turbo charger waste gate and cooler bypass valve systems are soot migrating into the motor, causing motor failure, rotor slippage, and encoder/sensors of the system failing due to the high ambient and radiant temperatures associated with an engine compartment environment.

### SUMMARY OF THE INVENTION

The present invention discloses an electric operated valve system that uses a non-contact cam profile sensor to control a valve. The sensor detects the motion of the cam, independent of actual motor rotor rotation, providing closed loop control. Since the sensor is detecting the motion of the cam independent of the actual rotor motor rotation, if the motor rotor does slip relative to the motor output shaft, it will not affect control of the valve.

More specifically, a system for operating a valve comprises a motor shaft driven by a motor; a first cam with a profile mounted to the motor shaft, a second cam with a profile mounted to the motor shaft; a non-contact sensor proximate to the first cam; and a valve actuator. The valve actuator follows the profile of the second cam. A selected position of the valve actuator may be set by activating the motor to a position determined by sensing the first cam profile by the non-contact sensor.

Additional passages may be present within the valve housing to deliver oil for lubrication and coolant.

### BRIEF DESCRIPTION OF THE DRAWING

FIG. 1 shows a cross-section of a system of a first embodiment of the present invention.

FIG. 2 shows a cross-section of a valve system of a second embodiment of the present invention.

FIG. 3 shows a cross-section of a valve system of a third embodiment of the present invention.

### DETAILED DESCRIPTION OF THE INVENTION

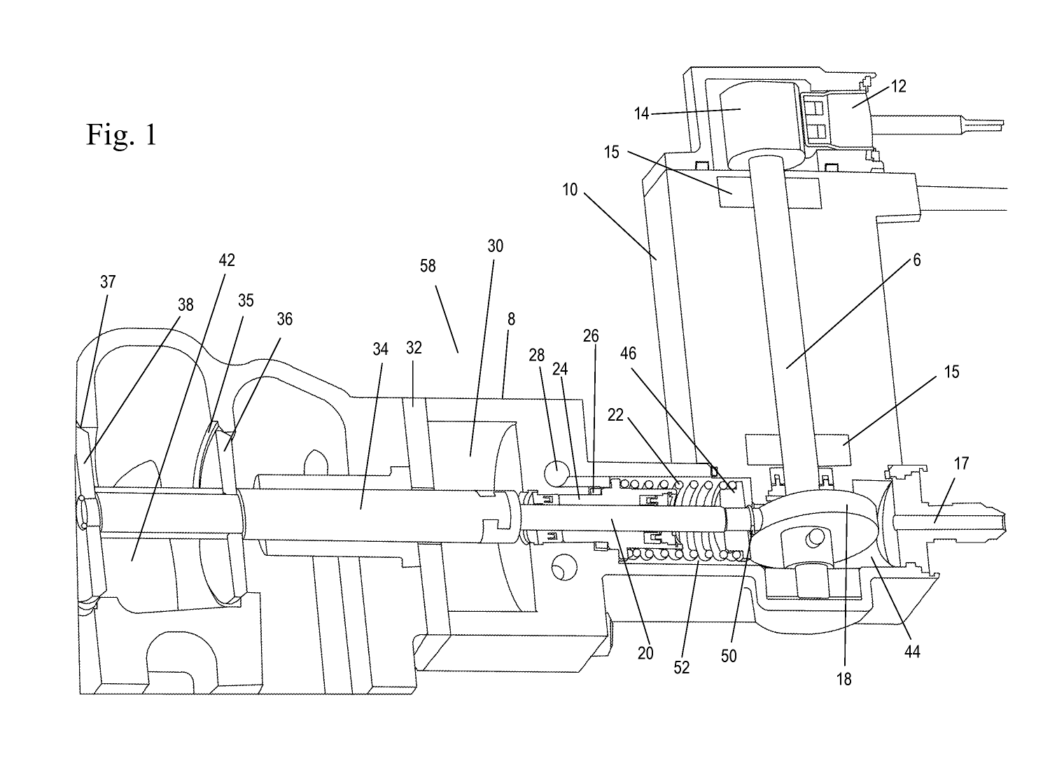

FIG. 1 shows a valve system of a first embodiment. The valve system includes a housing 8, a motor actuator 10, and valve 58 attached to a manifold.

The motor is connected to housing 8 of the valve assembly. The motor 10 has a motor shaft 6 that rotates and spans the length of the motor 10 with a first end having a first cam 14 mounted thereon and a second end, opposite the first end, having a second cam 18 mounted thereon. Portions of the shaft are supported by bearings 15 along its length.

The first cam 14 is aligned with a non-contact sensor 12. The non-contact sensor 12 senses the outer profile of the cam 14 as it rotates. The information from the non-contact sensor 12 is sent to and monitored by the ECU (not shown) where the relationship between the cam profile and the valve position has already been predetermined. Based on the information from the non-contact sensor 12 and other engine parameters the ECU adjusts the rotation of the motor shaft 6 via the motor 10, in turn adjusting the valve 58 position. The non-contact sensor 12 may also be mounted to sense the rotation of the cam 18.

The second cam 18 is received within a bore 44 of the valve housing 8. An oil passage 17 is present in a plug leading into the bore 44 from an engine pressurized oil supply (not shown) for providing lubricant to bore 44 and the second cam 18 as required, depending on thermal conditions. The second cam 18 contacts the end of the rod 20 that drives the balanced valve 58 through a shank body 34. This invention could also be utilized on a butterfly valve by a cam driving a rack and pinion connected to a butterfly valve shaft.

The rod 20 is received within the valve housing 8 and has a first end oriented to a second cam 18 and a second end connected to a shank body 34. The rod 20 is slidable along a central axis. A portion of the rod 20 is received by and guided within a second bore 52 of the housing 8 by a shaft guide 24. Also mounted to the rod 20 near the first end is a spring receiver 46 held on the rod 20 by a retainer 50. Seals 26 are present at both ends of the shaft guide 24 around the rod 20 to isolate lubricant and to protect the transmission and motor 10 from debris and soot. A spring 22 extends between the spring receiver 46 and the shaft guide 24. A passage 28 for cooling of the seals 26 and lubrication of the second cam 18 and bearings are also present within the valve housing 8 between the second bore 52 and the third bore 30 of the valve housing 8.

The second end of the rod 20 is coupled to the shank body 34 within a third bore 30 of the valve housing 8 provides a thermal break. The shank body 34 extends into the valve 58. Mounted to the shank body 34 are dual poppet heads 36, 38 which open and close to allow gas from the inlet passages to move to the combined outlet passage 42. The first poppet head 38 mates with a first seat 37 leading to the combined outlet passage 42 and the second poppet head 36 mates with a second seat 35 leading to the combined outlet passage 42. The inlet passages apply exhaust gas pressure to the two poppet heads 38, 36 from opposite directions to balance the dual poppet with respect to the inlet pressure. An additional thermal break 32 is present between the housing and the valve 58.

It would be obvious to one skilled in the art that the inlet and outlet chambers of the valve 58 may be reversed.

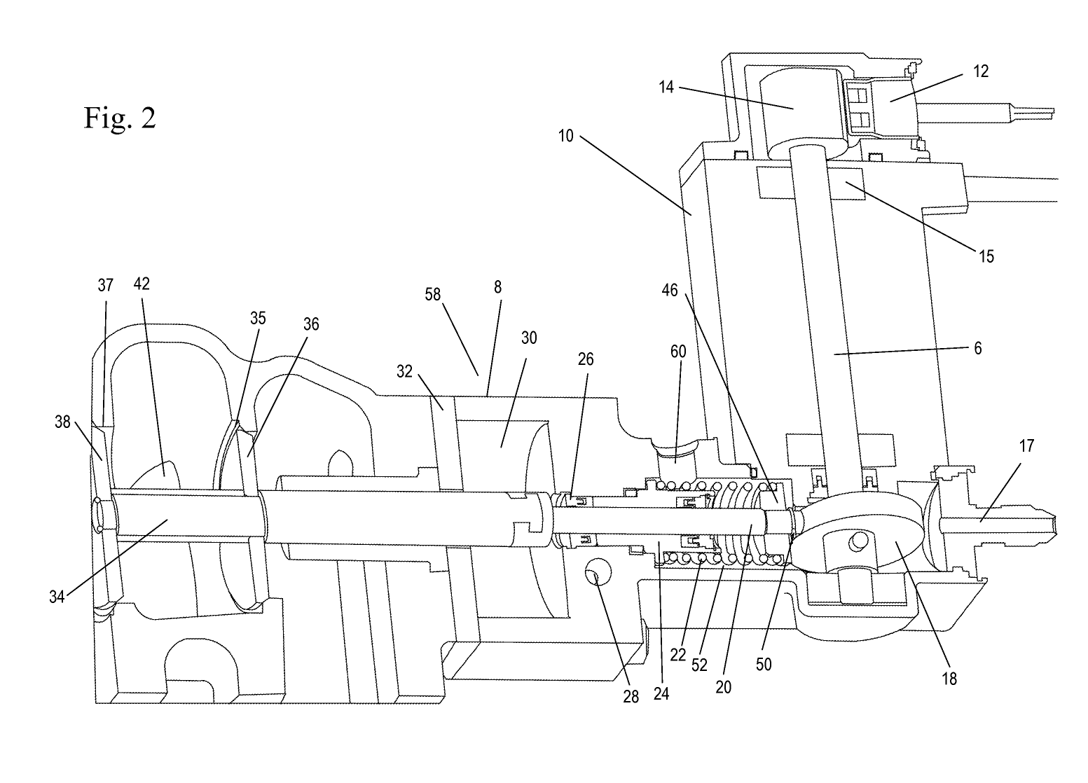

FIG. 2 shows a schematic of a second embodiment of the present invention. The valve system includes a housing 8, a motor actuator 10, and a valve 58 attached to a manifold. The difference between the first embodiment and the second embodiment is that the oil passage 60 for lubrication and cooling is separate from the water coolant passage 28 for the seal 26 and is located in the second bore of the valve housing 8. The lubrication and cooling is optional and is used depending on the thermal conditions present.

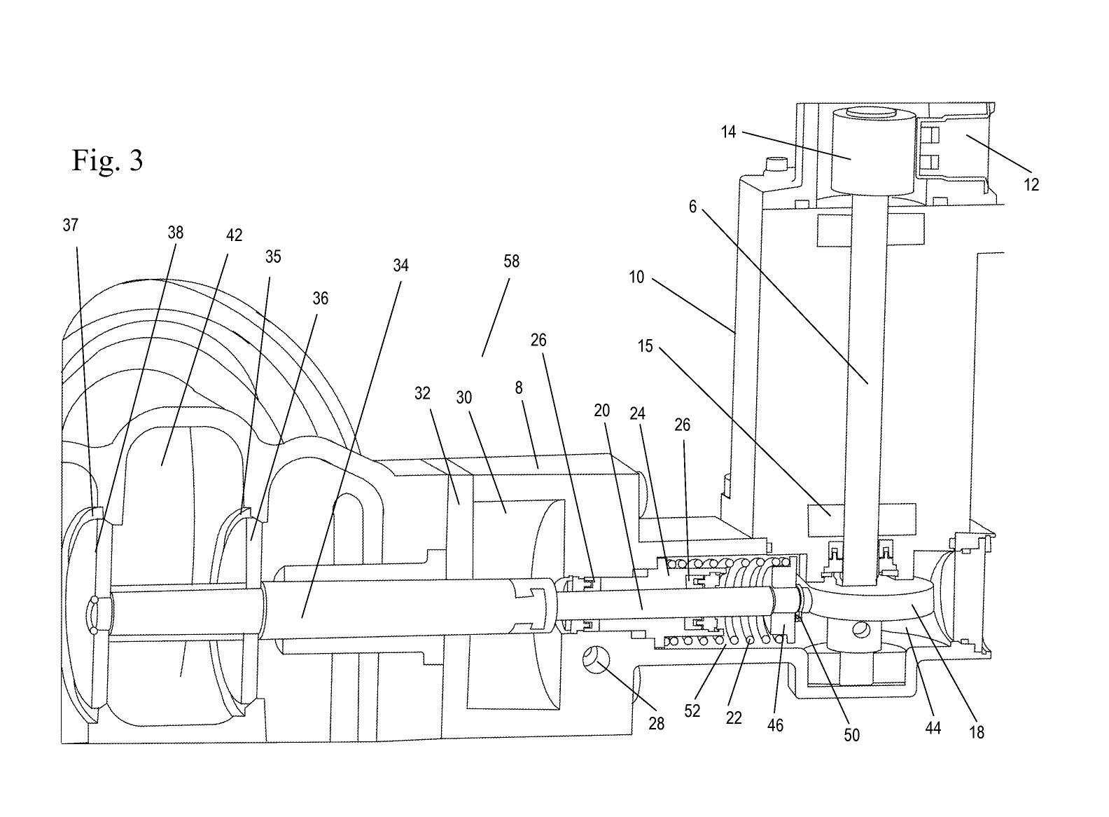

FIG. 3 shows a schematic of a third embodiment of the present invention. The valve system includes a valve housing 8, a motor actuator 10, and a valve 58 attached to a manifold. In this embodiment, first bore 44 of the valve housing 8 is filled with lubricant to lubricate the bearings 15 and the cam 18. The amount of lubricant is static. The water coolant passages 28 of the seals 26 are located in the valve housing 8 between the second 52 and third bores 30.

The present invention is not limited to the cam profiles shown in the Figures. The profiles may be any shape. The non-contact sensor may sense any portion of either cam dependent on its mounting location.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A valve assembly comprising:
a motor shaft driven by and directly coupled to a motor;
a first cam with a profile and a second cam with a profile, each mounted to the motor shaft;
a non-contact sensor proximate to the first cam sensing motion of the profile of the first cam; and
a valve actuator rod following the profile of the second cam;
wherein a selected position of the valve actuator may be set by activating the motor to a specific position determined by sensing motion of the profile of the first cam by the non-contact sensor.

2. The assembly of claim 1, wherein the valve actuator comprises:
a housing defining a first bore, a second bore, and a third bore, the second cam being received by the first bore, the rod being received by the second bore, and the body being coupled to the rod in the third bore of the valve housing.

3. The assembly of claim 2, further comprising an oil passage leading from a pressurized oil source to the first bore defined by the valve housing.

4. The assembly of claim 2, further comprising a passage in the valve housing between the second bore and third bore.

5. The assembly of claim 4, wherein the passage delivers oil as coolant to the second bore.

6. The assembly of claim 4, wherein the passage is split into a first passage for lubrication of the second bore and a second passage for cooling of the second bore.

7. The assembly of claim 4, wherein the passage delivers water as coolant to the second bore.

8. The assembly of claim 1, wherein the valve actuator further comprises dual poppet heads.
